(19) United States
(12) Patent Application Publication
(10) Pub. No.: US 2010/0183045 A1
(43) Pub. Date: Jul. 22, 2010

(54) SUBSTRATE TEMPERATURE MEASURING APPARATUS AND SUBSTRATE TEMPERATURE MEASURING METHOD

(75) Inventors: Ken Nakahara, Kyoto (JP); Masashi Kawasaki, Miyagi (JP); Akira Ohtomo, Miyagi (JP); Atsushi Tsukazaki, Miyagi (JP)

Correspondence Address: RABIN & Berdo, PC, 1101 14TH STREET, NW, SUITE 500, WASHINGTON, DC, 20005, US

(73) Assignee: ROHM CO., LTD., Kyoto (JP)

(21) Appl. No.: 12/452,809

(22) PCT Filed: Jul. 22, 2008
(86) PCT No.: PCT/JP2008/063117

§ 371 Date: Mar. 31, 2010

(30) Foreign Application Priority Data
Jul. 23, 2007 (JP) 2007-191358

(51) Int. Cl. G01J 5/00

(52) U.S. Cl. 374/130

(57) ABSTRACT

A substrate temperature measuring apparatus includes: a heating source that heat a substrate; a transmission window that transmits therethrough an infrared ray in a range of a wavelength at which the infrared ray cannot transmit through the substrate; and a temperature-measuring instrument having a sensitivity range including the range of the wavelength, and measuring a substrate temperature of the substrate by analyzing an infrared ray radiated from the substrate heated by the heating source and having transmitted through the transmission window.

### TECHNICAL FIELD

The present invention relates to a technology for measuring a temperature of a substrate, and particularly, relates to a substrate temperature measuring apparatus and a substrate temperature measuring method, which use an infrared ray radiated from the substrate.

### BACKGROUND ART

A zinc oxide (ZnO)-based semiconductor has large exciton binding energy, can stably exist even at room temperature, and is capable of emitting photons excellent in monochromaticity. Accordingly, application of the ZnO-based semiconductor is made to advance, which is performed for a light emitting diode to be used as a light source of a light, a backlight or the like, a high-speed electronic device, a surface acoustic wave device or the like. Here, “ZnO-based semiconductor” refers to a mixed crystal material using ZnO as a base, which includes a material in which zinc (Zn) is partially substituted by a Group IIA or Group IIB element, a material in which oxygen (O) is partially substituted by a Group VIB element, or a combination of both thereof.

Heretofore, in the case of using the ZnO-based semiconductor as a p-type semiconductor, there has been a problem that it is difficult to dope the ZnO-based semiconductor with an acceptor, resulting in difficulty obtaining a p-type ZnO-based semiconductor. Thanks to the progress of the technology, it has become possible to obtain the p-type ZnO-based semiconductor, and light emission from the p-type ZnO-based semiconductor has also come to be recognized (for example, refer to Non-Patent Citations 1 and 2).

In a semiconductor device, it is general to realize a desired function by depositing a plurality of thin films different in type and amount of impurities as a dopant, a plurality of thin films different in composition from each other, or the like. In this case, it is frequent that flatness of the thin film is a problem. This is because, if the flatness of the thin film is poor, then resistance when carriers move in the thin film is large, and in a stacked structure of the thin films, surface roughness (irregularities) is increased in a thin film formed afterward. If the surface irregularities are large, then uniformity in etching depth of the thin films cannot be maintained, and an anisotropic crystal surface is grown by the irregularities of the surface. As a result, there occurs a problem that the desired function of the semiconductor device cannot be realized. Therefore, it is desired that the surface of the thin film be flat.

Moreover, it has also been heretofore frequent that the ZnO film is grown on a sapphire substrate, but in recent years, a ZnO crystal substrate has become available in the market, and so-called homogeneous growth has become possible, in which a ZnO-based semiconductor film is grown on the ZnO crystal substrate.

[Non-Patent Citation 1] A. Tsukazaki, et al., Japanese Journal of Applied Physics vol. 44 (2005) p. 643

[Non-Patent Citation 2] A. Tsukazaki et al., Nature Material vol. 4 (2005) p. 42

### DISCLOSURE OF INVENTION

### Technical Problem

In order to perform crystal growth of a semiconductor film on the substrate while giving good flatness to a surface thereof, a temperature of the substrate is important. In general, in the case of growing a ZnO-based semiconductor film on the substrate heated to a desired temperature by a heating source, an infrared ray radiated from the substrate is measured by a radiation thermometer such as an infrared thermometer, and it is confirmed that a temperature of the substrate is the desired temperature.

However, in the case of using a substrate made of a wide-gap material, such as a ZnO-based substrate, a sapphire substrate and a gallium nitride (GaN) substrate, since the wide-gap material is transparent in a wide wavelength range, there has been a problem that the substrate temperature cannot be measured with high accuracy. Here, “transparent” refers to that an electromagnetic wave such as the infrared ray transmits through the substrate. In other words, in the case of using the substrate made of the wide-gap material, infrared rays radiated from the heating source that heats the substrate and from a holder that holds the substrate transmit through the substrate and reach the radiation thermometer, and there has occurred a problem that the substrate temperature cannot be measured with high accuracy.

### Technical Solution

In consideration of the foregoing problems, it is an object of the present invention to provide a substrate temperature measuring apparatus and a substrate, temperature measuring method, which are capable of measuring the substrate temperature with high accuracy.

In accordance with an aspect of the present invention, a substrate temperature measuring apparatus is provided, which includes: (A) a heating source that heat a substrate; (B) a transmission window that transmits therethrough an infrared ray in a range of a wavelength at which the infrared ray cannot transmit through the substrate; and (C) a temperature-measuring instrument that has a sensitivity range including the range of the wavelength, and measures a substrate temperature of the substrate by analyzing an infrared ray radiated from the substrate heated by the heating source and having transmitted through the transmission window.

In accordance with another aspect of the present invention, a substrate temperature measuring method is provided, which includes the steps of: (A) heating a substrate by a heating source, and making an infrared ray incident onto a temperature-measuring instrument through a transmission window, the infrared ray being radiated from the substrate and belonging to a range of a wavelength at which the infrared ray cannot transmit through the substrate, and the temperature-measuring instrument having a sensitivity range including the range of the wavelength; and (B) measuring a substrate temperature of the substrate by analyzing an infrared ray radiated from the substrate by the temperature-measuring instrument.

### ADVANTAGEOUS EFFECTS

In accordance with the present invention, the substrate temperature measuring apparatus and the substrate temperature measuring method, which are capable of measuring the substrate temperature with high accuracy, can be provided.

### BRIEF DESCRIPTION OF DRAWINGS

FIG. 1 is a schematic view showing a configuration of a substrate temperature measuring apparatus according to an embodiment of the present invention.

FIG. 2 is a schematic view showing an example of a semiconductor device of which substrate temperature is measured by the substrate temperature measuring apparatus according to the embodiment of the present invention.

FIGS. 3(a) to 3(e) are views showing examples of states of a surface of the semiconductor device shown in FIG. 2.

FIG. 4 is a graph showing an example of a relationship between arithmetic mean roughness of the surface and substrate temperature of the semiconductor device shown in FIG. 2.

FIG. 5 is a schematic diagram for explaining a roughness curve.

FIG. 6 is a graph showing an example of a relationship between root mean roughness of the surface and substrate temperature of the semiconductor device shown in FIG. 2.

FIG. 7 is a view showing an example of a surface state of an uppermost layer of the semiconductor device in which semiconductor layers are stacked on one another.

FIGS. 8(a) and 8(b) are graphs showing examples of characteristics of the semiconductor device: FIG. 8(a) is a graph showing nitrogen concentrations; and FIG. 8B is a graph showing a relationship between the substrate temperatures and the nitrogen concentrations.

FIG. 9 is a graph showing an example of a relationship between the nitrogen concentrations and growth temperatures of the semiconductor device.

FIG. 10 is a graph showing an example of a relationship between heater input voltages of a heating source and the substrate temperatures.

FIG. 11 is a graph showing an example of relationships between wavelengths of an infrared ray and transmittances thereof through a variety of materials.

FIG. 12 is a graph showing another example of the relationships between the wavelengths of the infrared ray and the transmittances thereof through the variety of materials.

### BEST MODE FOR CARRYING OUT THE INVENTION

Next, a description will be made of embodiments of the present invention with reference to the drawings. In the following description referring to the drawings, the same or similar reference numerals are assigned to the same or similar portions. Moreover, the embodiments described below illustrate an apparatus and a method, which are for embodying the technical idea of this invention, and the technical idea of this invention does not specify materials, shapes, structures, arrangements and the like of constituent components to those in the following description. The technical idea of this invention can be modified in various ways within the scope of claims.

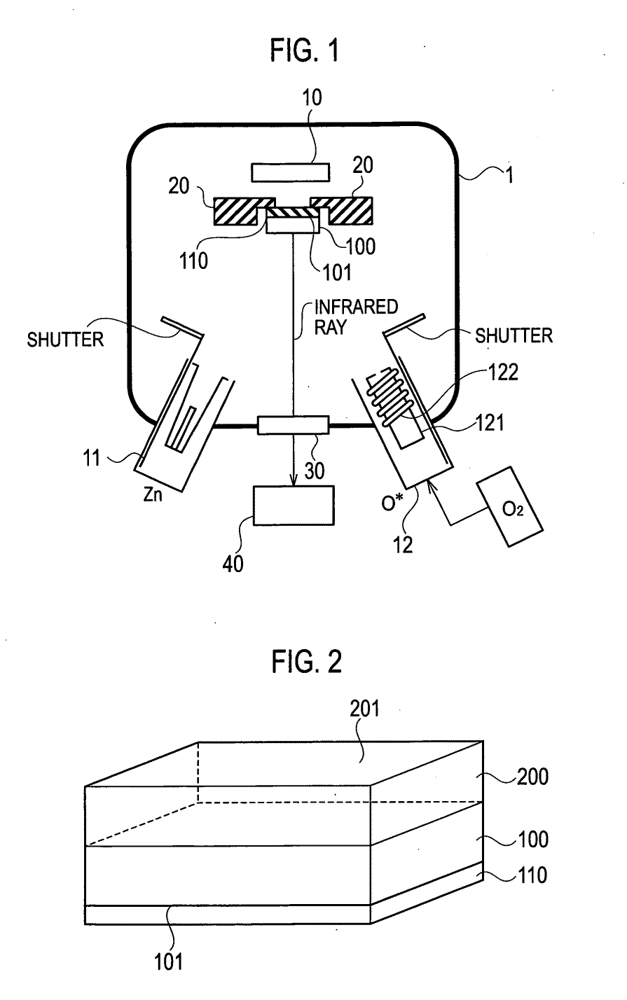

As shown in FIG. 1, a substrate temperature measuring apparatus according to the embodiment of the present invention includes: a heating source 10 that heat a substrate 100; a transmission window 30 that transmits therethrough an infrared ray in a range of a wavelength at which the infrared ray cannot transmit through the substrate 100; and a temperature-measuring instrument 40 that has a sensitivity range including the wavelength range, in which the electromagnetic wave cannot transmit through the substrate 100, and measures a substrate temperature of the substrate 100 by analyzing the infrared ray that is radiated from the substrate 100 heated by the heating source 10 and transmits through the transmission window 30. A metal film 110 is a film for efficiently absorbing the infrared ray radiated from the heating source, and is particularly effective when the substrate 100 is desired to be heated to a high temperature. In the case where it is not necessary to heat the substrate 100 to the high temperature, the metal film may be omitted. The substrate temperature measuring apparatus according to the embodiment of the present invention is used in combination with a crystal growth apparatus including a chamber 1. Temperature control is performed accurately in response to the measured temperature, whereby desired crystal growth can be realized.

The substrate temperature measuring apparatus shown in FIG. 1 further includes a holder 20 that mounts thereon the substrate 100, in which the metal film 110 is arranged on a back surface 101, while facing the back surface 101 to the heating source 10. For the holder 20, for example, stainless steel (SUS steel), Inconel or the like is adoptable. The heating source 10 and the holder 20 are arranged in the chamber 1, and the infrared ray radiated from the substrate 100 transmits through the transmission window 30, and is made incident onto the temperature-measuring instrument 40 arranged on the outside of the chamber 1.

For the heating source 10, adoptable is an infrared lamp, an infrared laser including light with a wavelength of 700 nm or more in a radiation spectrum thereof, or the like. For example, a carbon heater coated with silicon carbide (SiC) or the like is adoptable. A metal-based heater made of tungsten (W) and the like cannot be adopted as the heating source 10 since the heater is oxidized when an oxide such as the ZnO-based semiconductor is subjected to the crystal growth on the substrate 100; however, the heater is adoptable in the case of growing a film made of other than the oxide.

The transmission window 30 has a function to take out, to the outside of a manufacturing apparatus, an infrared ray with a wavelength at which it is difficult for the infrared ray to transmit through the substrate 100. For example, in the case where the substrate 100 is a ZnO-based substrate, a material that transmits therethrough an infrared ray with a wavelength of 8 μm or more is adoptable as the transmission window 30. This is because the ZnO-based substrate has low transmittance for the infrared ray with a wavelength of 8 μm or more as will be described later. To be specific, for example, barium fluoride (BaF₂) crystal or the like is adoptable as the material of the transmission window 30.

The sensitivity range of the infrared ray measurable by the temperature-measuring instrument 40 is set so as to include a wavelength range of the infrared ray that cannot transmit through the substrate 100, but can transmit through the transmission window 30. Here, “sensitivity range” is a wavelength range of an infrared ray received by the temperature-measuring instrument 40 and analyzable thereby. For example, in the case where the substrate 100 is the ZnO-based substrate, the sensitivity range is set at 8 μm or more, and for example, is set in a wavelength range of 8 μm to 14 μm. The temperature-measuring instrument 40 is set so as to measure an electromagnetic wave with a long wavelength, and thereby can measure the substrate temperature of the substrate 100 to a low temperature as will be described below. To be specific, based on the Plank's black body radiation law, a relationship between a peak wavelength λp of the radiation and a temperature Ts is established as follows:

(A) when Ts=30° C., λp=9.56 μm;

(B) when Ts=100° C., λp=7.77 μm;

(C) when Ts=500° C., λp=3.75 μm; and

(D) when Ts=1000° C., λp=2.27 μm.

Specifically, the lower the temperature is, the shorter the peak wavelength of the radiation is. Hence, the sensitivity range of the temperature-measuring instrument 40 includes peak wavelengths of the radiation radiated from the substrate 100 in the case where the substrate temperature is low. Meanwhile, since the high temperatures go out of the sensitivity range, for example, a filter that cuts a short wavelength side is mounted in usual in a case where the substrate temperature exceeds 500° C., whereby the substrate temperature is measured after being calibrated.

For the temperature-measuring instrument 40, for example, a thermography is adoptable. As well known, the thermography is an apparatus that analyzes an infrared ray radiated from an object, and enables visualization of a thermal distribution therefrom as an illustration. In the case of adopting the thermography for the temperature measuring apparatus 40, the temperature measuring apparatus 40 analyzes the infrared ray radiated from the substrate 100, and measures a thermal distribution of the substrate 100 heated by the heating source 10.

Moreover, in the case of adopting the thermography for the temperature measuring apparatus 40, it is preferable that the thermography include an infrared detection instrument of a bolometer type. This is because a non-cooling-type infrared thermography using an infrared detection instrument of a heat type such as the bolometer type and a pyroelectric type is capable of miniaturization, weight reduction and cost reduction thereof in comparison with the case of including an infrared array sensor using a quantum-type infrared detection instrument necessary to be cooled.

In the following, the case will be illustratively described, where the substrate 100 is a ZnO-based substrate made of ZnO or a ZnO-based material such as MgₓZn₁₋ₓO (0≦x<1) mixed with magnesium (Mg). Moreover, for the metal film 110 arranged on the back surface 101 of the substrate 100, adoptable is a metal film with a structure in which titanium (Ti) and platinum (Pt) are stacked on each other, or the like.

At present, in order to form the ZnO-based semiconductor film with high purity, it is general to adopt the molecular beam epitaxy (MBE) method. The MBE method uses element materials as raw materials, and accordingly, can increase purities of the element materials when the element materials are still the raw materials in comparison with the metal-organic chemical vapor deposition (MOCVD) method using a compound material.

As shown in FIG. 1, the chamber 1 further includes a cell 11 and a cell 12, which supply the raw materials of the thin film to be subjected to the crystal growth on the substrate 100. To be specific, the substrate temperature measuring apparatus shown in FIG. 1 functions as an apparatus that performs the crystal growth for the thin film while measuring the substrate temperature of the substrate 100 with high accuracy. In the example shown in FIG. 1, zinc (Zn) is supplied from the cell 11. The cell 12 is a radical generation instrument, and is used in the case of applying the MBE method to crystal growth of a compound of the ZnO film or the like, which contains a gaseous element. The radical generation instrument usually has a structure in which a high frequency coil 122 is wound around an outer circumferential side of a discharge tube 121 made of pyrolytic boron nitride (PBN) or quartz, and the high frequency coil 122 is connected to a high frequency power supply (not shown). In the example shown in FIG. 1, a high frequency voltage (electric field) is applied to oxygen (O), which is supplied into the cell 12, by the high frequency coil 122, whereby plasma is generated therein, and plasma particles (O*) are supplied from the cell 12.

It will be described below that the substrate temperature is important in order to perform the crystal growth for the thin film made of the ZnO-based semiconductor while giving good flatness to the surface thereof. As an example, the case as shown in FIG. 2 will be described below, where a semiconductor layer 200 made of the ZnO-based semiconductor is subjected to the crystal growth on the surface of the substrate 100 as the ZnO-based substrate in which the metal film 110 is arranged on the back surface 101. FIG. 2 shows the case where the semiconductor layer 200 formed on the substrate 100 is single. In the case of stacking a plurality of the ZnO-based semiconductors on the substrate 100, it is necessary to perform the crystal growth for each of the plurality of ZnO-based semiconductors while giving good flatness to surfaces thereof. Note that a principal surface 201 of the semiconductor layer 200 is used as a surface on which another semiconductor layer is grown, or the like.

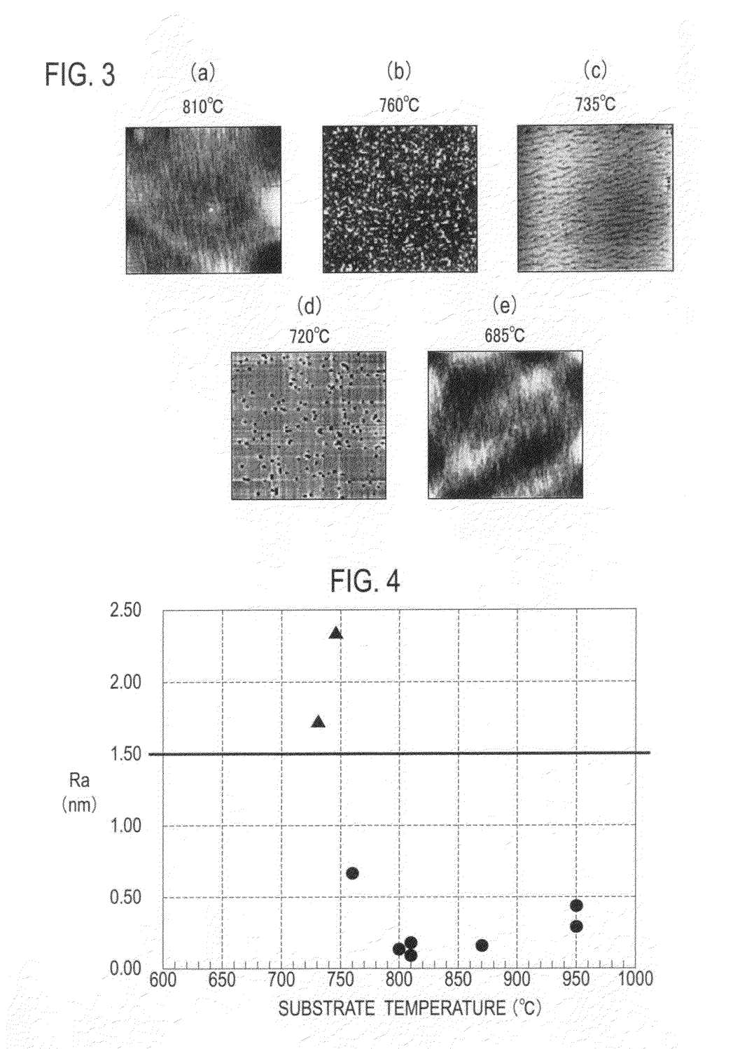

FIGS. 3(a) to 3(e) show states of the principal surface 201 of the semiconductor layer 200 in the case of epitaxially growing the semiconductor layer 200 made of the ZnO-based semiconductor layer on the substrate 100 shown in FIG. 1 by the MBE method. To be specific, FIGS. 3(a) to 3(e) show examples of states of the principal surface 201 in the case of growing the semiconductor layer 200 made of ZnO on the substrate 100 made of MgₓZn₁₋ₓO while changing the substrate temperature. FIGS. 3(a) to 3(e) are images obtained by scanning states of the principal surface 201 in the case where the substrate temperatures are 810° C., 760° C., 735° C., 720° C. and 685° C., respectively at resolving power of 20 μm by using an atomic force microscope (AFM).

As shown in FIGS. 3(c), 3(d) and 3(e), in the cases where the substrate temperatures are 735° C. or lower, scattering of irregularities is conspicuous on the principal surface 201. Meanwhile, as shown in FIGS. 3(a) and 3(b), in the cases where the substrate temperatures are 760° C. or higher, the principal surface 201 is in a clean state with fewer irregularities, and the semiconductor layer 200 of the state where the flatness of the principal surface 201 is good is formed.

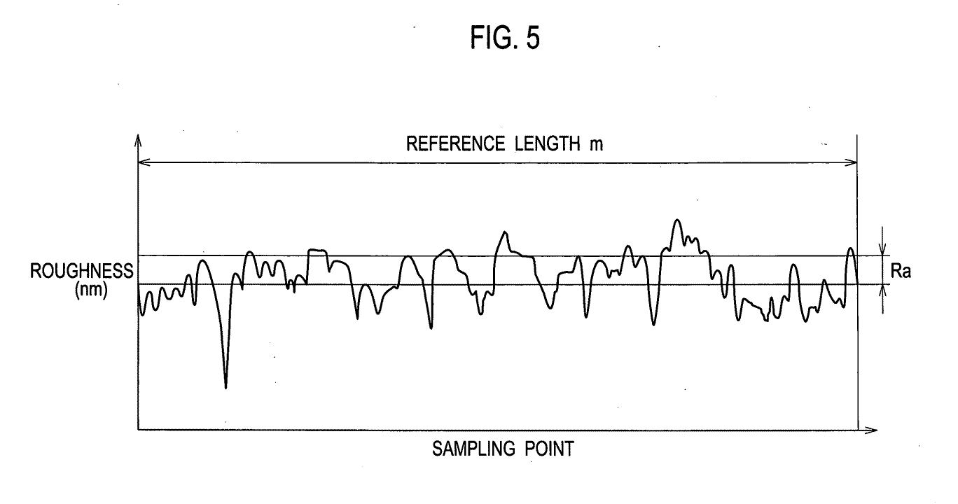

The substrate temperature is changed not only to the temperatures shown in FIGS. 3(a) to 3(e) but also more finely, and the flatness of the principal surface 201 of the semiconductor layer 200 made of ZnO at each of the substrate temperatures is represented as a numerical value, and the respective numerical values are then graphed. FIG. 4 shows results of graphing the numerical values. An axis of ordinates of FIG. 4 represents arithmetic mean roughness Ra of the principal surface 201 of the semiconductor layer 200. “Arithmetic mean roughness” Ra is obtained by using a roughness curve illustrated in FIG. 5.

The roughness curve represents sizes of irregularities on the principal surface 201 of the semiconductor layer 200, which are measured at predetermined sampling points, together with mean values of the irregularities. Then, the arithmetic mean roughness Ra is a value obtained in such a manner that the roughness curve is extracted by a reference length m in a direction of a mean line thereof, and absolute values of deviations from the mean line of the extracted portion to a measured curve thereof are summed up and averaged. In other words, the arithmetic mean roughness Ra is obtained by the following Expression (1):

Ra=(1/m)×∫|f(x)|dx (1)

An integration section of Expression (1) is 0 to m.

The arithmetic mean roughness Ra is obtained, whereby a highly reliable evaluation value for the roughness is obtained, for example, in which an influence given by one scratch to the entirety is extremely reduced. Note that parameters of the surface roughness such as the arithmetic mean roughness Ra are defined in the JIS standard, and these parameters are used in the embodiment of the present invention.

FIG. 4 is a graph that represents the flatness of the principal surface 201, in which the arithmetic mean roughness Ra calculated as described above is taken on the axis of ordinates, and the substrate temperature is taken on an axis of abscissas. Black triangle symbols in FIG. 4 indicate data when the substrate temperature is lower than 750° C., and black circle symbols therein indicate data when the substrate temperature is 750° C. or higher. As seen from FIG. 4, when the temperature is higher than 750° C. taken as a threshold, the flatness of the principal surface 201 of the semiconductor layer 200 is radically enhanced. Moreover, when a threshold to determine quality of the flatness in the arithmetic mean roughness Ra is set based on FIG. 4, the threshold is approximately 1.5 nm when the arithmetic mean roughness Ra is taken loosely, and is approximately 1.0 nm when the arithmetic mean roughness Ra is taken strictly.

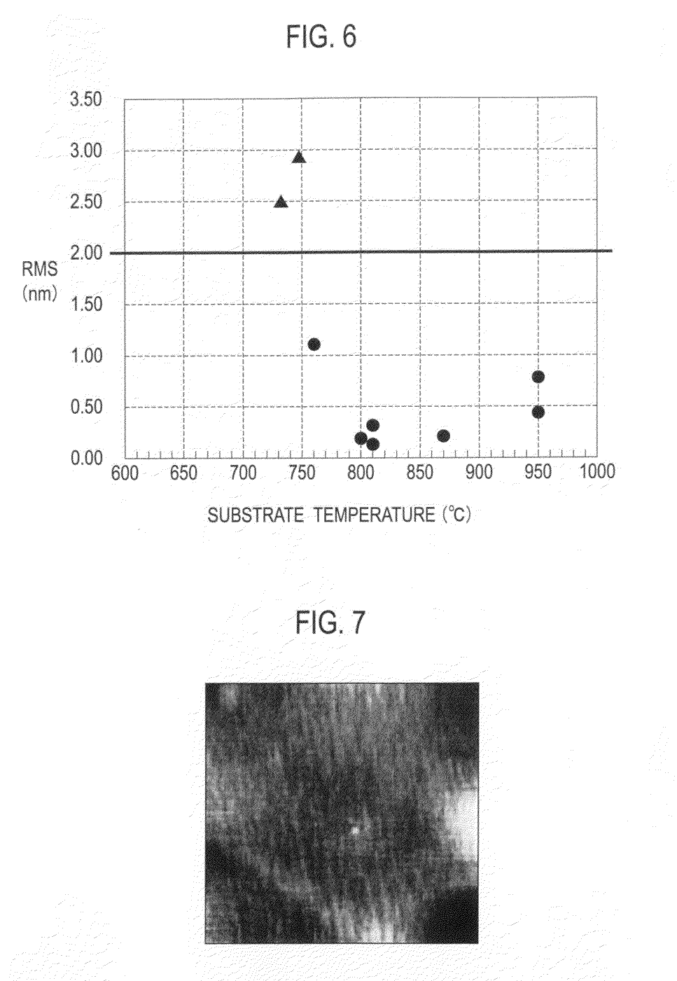

FIG. 6 is a graph showing root mean roughness RMS of the principal surface 201, which is obtained from the same measurement data as that used in FIG. 4. The root mean roughness RMS is represented as a square root of a value obtained in such a manner that squares of the deviations from the mean line of the surface roughness measured as shown in FIG. 5 to the measured curve thereof are summed up and averaged. By using the reference length m at the time of calculating the arithmetic mean roughness Ra, the root mean roughness RMS is obtained by the following Expression (2):

RMS={(1/m)×∫(f(x))²dx}^{1/2} (2)

An integration section of Expression (2) is 0 to m.

An axis of ordinates of FIG. 6 represents the root mean roughness RMS, and an axis of abscissas thereof represents the substrate temperature. In FIG. 6, black triangle symbols indicate data when the substrate temperature is lower than 750° C., and black circle symbols indicate data when the substrate temperature is 750° C. or higher. In a similar way to FIG. 4, it is seen that, when the temperature is higher than 750° C. taken as the threshold, the flatness of the principal surface 201 is radically enhanced. With regard to the root mean roughness RMS, the threshold to determine the quality of the flatness is approximately 2.0 nm when being taken loosely, and is approximately 1.5 nm when being taken strictly.

Hence, in the case of growing the ZnO-based semiconductor on the ZnO-based substrate or on the ZnO-based semiconductor layer, the ZnO-based semiconductor is subjected to the crystal growth while setting the substrate temperature at 750° C. or higher, whereby the ZnO-based semiconductor in which the surface flatness is good is formed. Moreover, from a viewpoint of the surface roughness, if the growth surface (principal surface) of the semiconductor layer is subjected to the crystal growth so that the arithmetic mean roughness Ra is 1.5 nm or less and that the root mean roughness RMS is 2 nm or less, then the ZnO-based semiconductor layer to be thereafter stacked thereon can also maintain the flatness of the surface thereof. More preferably, the ZnO-based semiconductor layer is subjected to the crystal growth so that the arithmetic mean roughness Ra is 1 nm or less, and that the root mean roughness RMS is 1.5 nm or less.

FIG. 7 shows an example of a state of the principal surface (surface) of the uppermost layer in the case of stacking the plurality of ZnO-based semiconductor layers on each other under the above-described conditions. FIG. 7 is an image obtained by scanning the state of the principal surface of the uppermost layer at the resolving power of 20 μm by using the AFM in a similar way to FIGS. 3(a) to 3(e). To be specific, FIG. 7 shows an example of a state of a principal surface of the uppermost layer in the case of using Mg_{0.2}Zn_{0.8}O as the ZnO-based substrate, and as a stacked body of the ZnO-based semiconductors, stacking Mg_{0.1}Zn_{0.9}O layers and ZnO layers alternately in ten cycles on the substrate concerned. The substrate temperature was set at 770° C. Even in the case as described above, where the thin films with the mixed crystal composition are stacked, the ZnO-based semiconductor in which the flatness of the surface of the uppermost layer in the stacked structure is good is obtained as shown in FIG. 7 in such a manner that the flatness of the principal surface of each of the semiconductor layers is maintained constantly by setting the substrate temperature at 750° C. or higher.

As described above, the substrate temperature is important in order to perform the crystal growth for the ZnO-based semiconductor while giving the good flatness thereto. Then, it is necessary to accurately measure and control the substrate temperature. Note that the ZnO-based semiconductor has a hexagonal structure called wurtzite. In the substrate 100 shown in FIG. 2, the semiconductor layer 200 is subjected to the crystal growth on a +c-plane of a hexagonal system, a −c-plane thereof is used as the back surface 101, and the metal film 110 is arranged on the −c-plane.

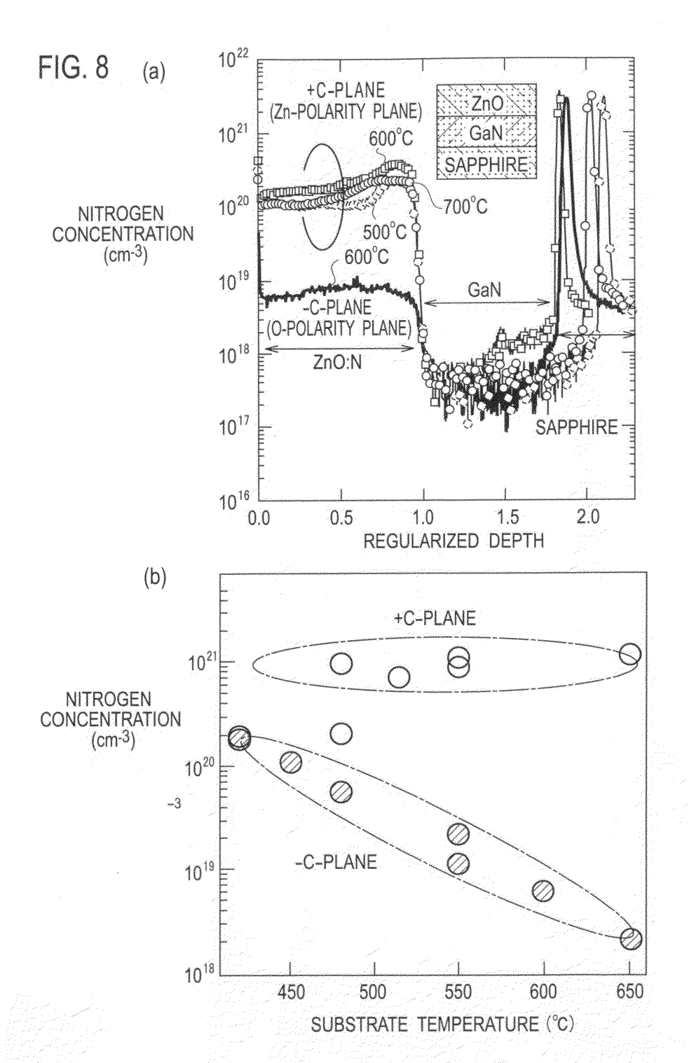

FIGS. 8(a) and 8(b) show characteristics of the +c-plane of the ZnO-based semiconductor. FIG. 8(a) is a graph showing nitrogen (N) concentrations of a sample in which a gallium nitride (GaN) film and a ZnO film are stacked on a sapphire substrate. In FIG. 8(a), the nitrogen concentrations are taken on an axis of ordinates, and distances in a depth direction from the surface of the ZnO film as an origin are taken on axis of abscissas. FIG. 8(a) shows nitrogen concentrations in the +c-plane (Zn-polarity plane) in the cases where the substrate temperatures were set at 500° C., 600° C. and 700° C., and nitrogen concentrations in the −c-plane (O-polarity plane) in the case where the substrate temperature was set at 600° C. FIG. 8(b) is a graph showing a relationship between the nitrogen concentrations in the +c-plane and the −c-plane and the substrate temperatures. In FIG. 8(b), the nitrogen concentrations are taken on an axis of ordinates, and the substrate temperatures are taken on axis of abscissas. In FIG. 8(b), outlined white circle symbols indicate the nitrogen concentrations in the +c-plane, and hatched circle symbols indicate the nitrogen concentrations in the −c-plane. If the ZnO-based semiconductor is in the state shown in FIG. 8(b), then dependency of the nitrogen concentrations in the +c-plane on the substrate temperature is small, and from a viewpoint of the nitrogen concentrations in the +c-plane, there is no problem even if the measurement accuracy of the substrate temperature is somewhat low. However, as already described, the measurement accuracy of the substrate temperature is important from a viewpoint of the flatness of the +c-plane of the ZnO-based semiconductor.

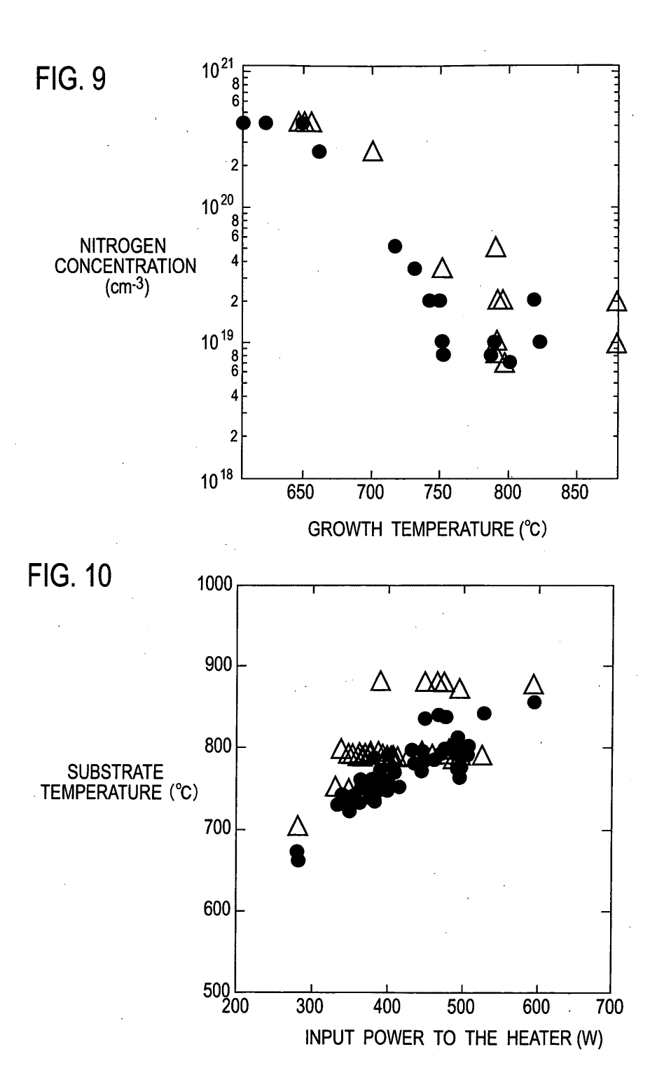

FIG. 9 shows an example of a relationship between the nitrogen concentrations and growth temperatures (substrate temperatures) in the case of measuring the substrate temperature by individually using a pyrometer and the thermography and performing the crystal growth for the semiconductor layer 200 on the substrate 100. An axis of ordinates in FIG. 9 represents the nitrogen concentrations, and an axis of abscissas therein represents the growth temperatures. Outlined triangle symbols in FIG. 9 indicate data in the case of measuring the growth temperature by using the pyrometer, and black circle symbols indicate data in the case of measuring the growth temperature by using the thermography.

As shown in FIG. 9, in the case where the substrate temperature is 650° C. or higher, the growth temperature (substrate temperature) dependency of the nitrogen concentrations is observed even in the +c-plane. However, in comparison with the case of measuring the substrate temperature by using the pyrometer, the relationship between the nitrogen concentrations and the growth temperatures is more linear in the case of measuring the substrate temperature by using the thermography, and in this case, the substrate temperature dependency of the nitrogen concentrations is represented more clearly. This is convenient for the control.

FIG. 10 is a graph showing a relationship between input powers to the heater for use in the heating source and the substrate temperatures measured by individually using the pyrometer and the thermography. Outlined triangle symbols in FIG. 10 indicate data in the case of measuring the substrate temperature by using the pyrometer, and black circle symbols therein indicate data in the case of measuring the substrate temperature by using the thermography. As shown in FIG. 10, in comparison with the case of measuring the substrate temperature by using the pyrometer, the relationship between the input powers to the heater and the substrate temperatures is more linear in the case of measuring the substrate temperature by using the thermography, and in this case, dependency of the substrate temperature on the input power to the heater is represented more clearly.

Referring to FIG. 9 and FIG. 10, it can be said that the substrate temperature can be measured with higher accuracy in the case of using the thermography rather than the pyrometer for the measurement of the substrate temperature.

For example, in the case where the substrate 100 has transmittance of 80% or more for an infrared ray with a wavelength approximately ranging from 1 to 2 μm, the substrate 100 can be regarded to be transparent in this approximate infrared range of 1 to 2 μm. In this case, by means of the pyrometer that measures the infrared ray with the approximate wavelength range of 1 to 2 μm, the infrared rays radiated from the heating source 10 and the holder 20 are regarded to be the infrared ray that has transmitted through the substrate 100, and the substrate temperature cannot be measured with high accuracy. As shown in FIG. 2, the metal film 110 is arranged on the back surface 101 of the substrate 100 so as to be opposite to the heating source 10, whereby the infrared rays radiated from the heating source 10 and the holder 20 are reflected on the metal film 110, and it is thereby possible to prevent the infrared rays from transmitting through the substrate 100. However, in some case, the oxide formed on the junction surface between the substrate 100 and the metal film 110 is not formed uniformly, and the substrate temperature cannot be measured with high accuracy.

However, the substrate temperature measuring apparatus shown in FIG. 1 measures the substrate temperature by using the infrared ray in the range of the wavelength at which the infrared ray cannot transmit through the substrate 100, and accordingly, can measure the substrate temperature with high accuracy even if there is the problem as described above that the junction surface between the substrate 100 and the metal film 110 is not uniform.

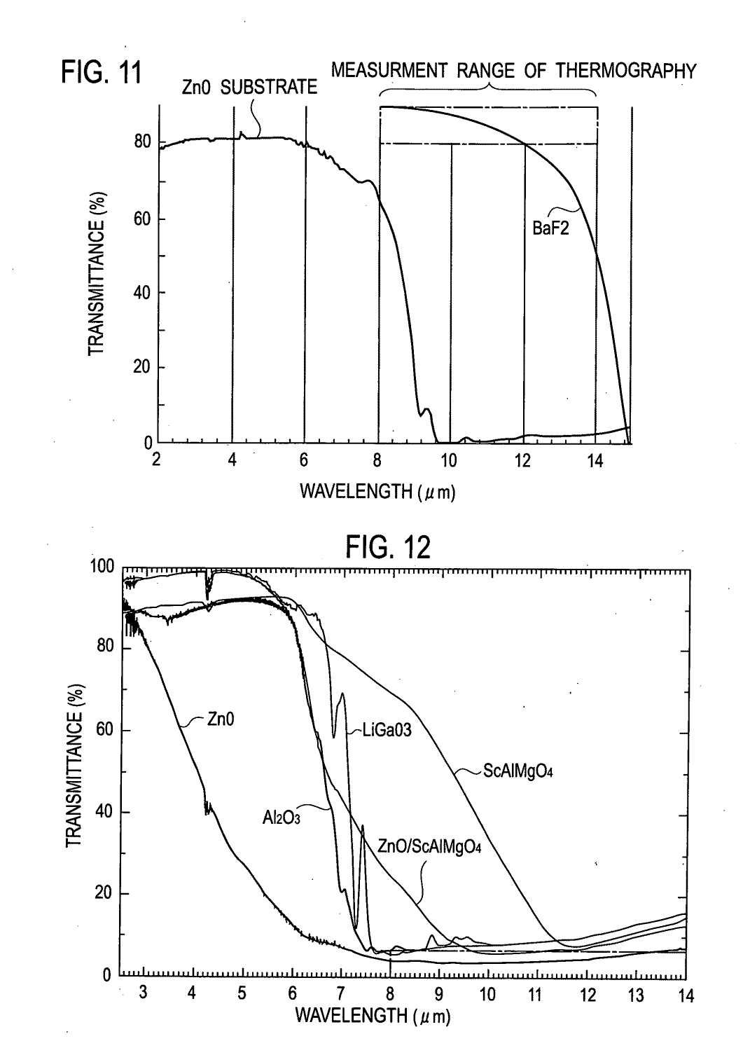

FIG. 11 shows a relationship between wavelengths of an infrared ray and transmittances through ZnO and BaF₂. FIG. 11 shows the sensitivity range of the wavelengths measurable by the thermography adoptable for the temperature-measuring instrument 40. In the wavelengths of 8 μm or more, which is a lower limit of the sensitivity range of the thermography, the transmittance of the infrared ray through ZnO is radically decreased. Meanwhile, the transmittance of the infrared ray in a wavelength range of 8 to 12 μm through BaF₂ is 80% or more. Here, the wavelength range of 8 to 12 μm is included in the sensitivity range.

FIG. 12 shows relationships between the wavelengths of the infrared ray and transmittances thereof through ZnO, Al₂O₃, LiGaO₃, ScAlMgO₄ and ZnO/ScAlMgO₄. As shown in FIG. 12, in the case where the sensitivity, range of the wavelength range measurable by the thermography adoptable for the temperature-measuring instrument 40 is set at 8 μm to 14 μm, the infrared ray with the wavelength included in the sensitivity range of the thermography can hardly transmit through the ZnO-based substrate or the sapphire substrate. Note that a difference in wavelength dependency of the transmittances between ZnO and ZnO/ScAlMgO₄ occurs since a carrier concentration of ZnO is higher than that of ZnO/ScAlMgO₄ by approximately one digit.

Hence, for example, in the case where the substrate 100 is the ZnO-based substrate, the infrared ray with a wavelength of 8 μm or more, which is irradiated from the heating source 10, is not allowed to transmit through the substrate 100 and does not reach the temperature-measuring instrument 40. Moreover, even if the holder 20 is arranged on the entirety of the back surface 101 of the substrate 100, the infrared ray with a wavelength of 8 μm or more, which is irradiated from the holder 20, is not allowed to transmit through the substrate 100 and does not reach the temperature-measuring instrument 40. In other words, only the infrared ray with a wavelength of 8 μm or more, which is emitted by ZnO, is measured.

Therefore, in accordance with the substrate temperature measuring apparatus shown in FIG. 1, BaF₂ is adopted as the material of the transmission window, 30, and the thermography in which the wavelength of the sensitivity range is 8 μm or more is adopted as the temperature-measuring instrument 40, whereby only the infrared ray radiated from the substrate 100 as the ZnO-based substrate transmits through the transmission window 30. Then, the temperature-measuring instrument can measure the substrate temperature with high accuracy by analyzing the infrared ray thus transmitted. In other words, in the crystal growth apparatus including the substrate temperature measuring apparatus shown in FIG. 1, the ZnO-based semiconductor layer can be subjected to the crystal growth on the substrate 100 while measuring the substrate temperature of the substrate 100 with high accuracy. In such a way, it becomes possible to make comparison of the crystal growth conditions more accurately among different crystal growth apparatuses.

Moreover, in the crystal growth apparatus including the substrate temperature measuring apparatus shown in FIG. 1, a crystal growth temperature can be switched, for example, in response to the layers to be grown. In other words, a crystal growth method in which the temperature is switched based on the substrate temperature measured by the substrate temperature measuring apparatus can be realized.

A description will be made below of a method of performing the crystal growth for the ZnO-based semiconductor layer by using the substrate temperature measuring apparatus shown in FIG. 1. Note that the method of growing the ZnO-based semiconductor layer, which will be described below, is merely an example, and it is a matter of course that the growth of the ZnO-based semiconductor layer is realizable by other various growth methods including modification examples thereof.

(A) First, the metal film 110 with a structure, for example, in which Ti with a film thickness of approximately 10 nm and Pt with a film thickness of approximately 100 nm are stacked on each other, is formed by the electron beam (EB) evaporation method or the like on the back surface (−c-plane) 101 of the substrate 100 as the ZnO-based substrate in which the principal surface is the +c-plane.

(B) Subsequently, the substrate 100 in which the metal film 110 is arranged on the back surface 101 is mounted on the holder 20 while facing the back surface 101 to the heating source 10. Then, as shown in FIG. 1, the substrate 100 set on the holder 20 is loaded into the chamber 1 from a load lock.

(C) In vacuum, for example, of approximately 1×10⁻⁷ Pa, the substrate 100 is heated by the heating source 10 until the temperature of the substrate 100 reaches a preset substrate temperature. The set substrate temperature is set at 750° C. or higher. At this time, the infrared ray that is radiated from the substrate 100 heated by the heating source 10 and has transmitted through the transmission window 30 is entered into the temperature-measuring instrument 40. The temperature-measuring instrument 40 analyzes the infrared ray radiated from the substrate 100, and measures the substrate temperature of the substrate 100.

(D) While confirming that the substrate temperature is the preset substrate temperature by the temperature-measuring instrument 40, NO gas, O₂ gas or the like is supplied to the cell 12, whereby the plasma is generated. Then, shutters of the cell 11 and the cell 12 are opened, and the oxygen source turned to an oxygen radical state in which reaction activity is increased is supplied into the chamber 1 together with Zn adjusted in advance so that a desired composition can be established. In such a way, the semiconductor layer 200 made of ZnO is grown on the +c-plane of the substrate 100.

As described above, in accordance with the method of performing the crystal growth by using the substrate temperature measuring apparatus shown in FIG. 1, the substrate temperature can be measured with high accuracy, and accordingly, the semiconductor layer 200 can be subjected to the crystal growth on the substrate 100 while giving good flatness to the surface thereof.

As described above, the substrate temperature measuring apparatus according to the embodiment of the present invention includes: the transmission window 30 that transmits therethrough the infrared ray in the range of the wavelength at which the infrared ray cannot transmit through the substrate 100; and the temperature-measuring instrument 40 in which the sensitivity range is the wavelength range as described above. In such a way, the infrared ray radiated from the heating source 10 or the holder 20 can be removed, and the substrate temperature can be measured with high accuracy. For example, in accordance with the substrate temperature measuring apparatus shown in FIG. 1, which includes: the transmission window 30 in which the transmittance of the infrared ray with a wavelength of 8 μm or more is 80% or more; and the temperature-measuring instrument 40 in which the sensitivity range of the measurable infrared rays is 8 μm or more, the substrate temperature can be measured with high accuracy even if the substrate has transmittance of 80% or more, for example, for the infrared ray with an approximate wavelength range of 1 to 2 μm. As a result, the ZnO-based semiconductor can be subjected to the crystal growth, for example, on the ZnO-based substrate while giving good flatness to the surface thereof.

Note that, with regard to the wavelength of the infrared ray that transmits through the transmission window 30 and is analyzed by the temperature-measuring instrument 40, even if the transmittance of the infrared ray with the wavelength concerned through the substrate 100 is not 0%, if the transmittance concerned is to an extent to allow the substrate 100 to be observed black in the thermography, then the substrate temperature measuring apparatus according to the embodiment of the present invention is usable. For example, in the case where the substrate 100 is the ZnO-based substrate, the transmittance of the infrared ray with a wavelength of 8 μm through the substrate 100 is several percents, and in this case, the substrate 100 looks black in the observation using the thermography. In other words, the infrared ray radiated from the object located behind the substrate 100 when viewed from the temperature-measuring instrument 40 is shielded by the substrate 100, and the substrate temperature can be measured with high accuracy by the temperature-measuring instrument 40 based on the infrared ray radiated from the substrate 100. Moreover, the crystal growth method in which the temperature control is performed based on the substrate temperature measured with high accuracy can be realized.

### Other Embodiments

As described above, the present invention has been described based on the embodiment; however, it should not be understood that the description and the drawings, which form a part of the disclosure, limit this invention. From this disclosure, a variety of alternative embodiments, examples and operation technologies will be obvious for those skilled in the art.

In the description of the embodiment already mentioned, the example where the semiconductor layer is subjected to the crystal growth on the ZnO-based substrate has been illustrated; however, the substrate may be a substrate made of a wide-gap material, for example, such as a sapphire substrate and a GaN substrate, which is other than the ZnO-based substrate.

Moreover, the present invention is also applicable to measurement of the substrate temperature in other processes than the process for forming the thin film on the substrate by the crystal growth. The other processes include those in which the control of the substrate temperature is important, for example, annealing treatment for activating the impurities as the dopant.

Specifically, it is a matter of course that the present invention incorporates a variety of embodiments and the like, which are not described herein. Hence, the technical scope of the present invention should be determined only by the invention specifying items according to the scope of claims reasonable from the above description.

### INDUSTRIAL APPLICABILITY

The substrate temperature measuring apparatus of the present invention and the substrate temperature measuring method thereof are usable for the semiconductor industry and the electronic instrument industry, which include a manufacturing industry that manufactures the semiconductor device in which the semiconductor layer is formed on the substrate.

1. A substrate temperature measuring apparatus comprising:
a heating source configured to heat a substrate;
a transmission window that transmits therethrough an infrared ray in a range of a wavelength at which the infrared ray cannot transmit through the substrate; and
a temperature-measuring instrument with a sensitivity range including the range of the wavelength, the temperature-measuring instrument measuring a substrate temperature of the substrate by analyzing an infrared ray radiated from the substrate heated by the heating source and having transmitted through the transmission window.

2. The substrate temperature measuring apparatus of claim 1, wherein transmittance of an infrared ray in at least a part of the range of the wavelength through the transmission window is 80% or more.

3. The substrate temperature measuring apparatus of claim 1, wherein transmittance of an infrared ray with a wavelength of 8 μm through the transmission window is 80% or more.

4. The substrate temperature measuring apparatus of claim 3, wherein the transmission window is made of barium fluoride.

5. The substrate temperature measuring apparatus of claim 3, wherein the sensitivity range of the wavelength of the temperature-measuring instrument is 8 μm or more.

6. The substrate temperature measuring apparatus of claim 1, wherein the temperature-measuring instrument is a thermography.

7. The substrate temperature measuring apparatus of claim 6, wherein the thermography includes an infrared detection instrument of a bolometer type.

8. The substrate temperature measuring apparatus of claim 1, wherein the heating source is an infrared lamp or an infrared laser.

9. A substrate temperature measuring method comprising:
heating a substrate by a heating source, and making an infrared ray incident onto a temperature-measuring instrument through a transmission window, the infrared ray being radiated from the substrate and belonging to a range of a wavelength at which the infrared ray cannot transmit through the substrate, and the temperature-measuring instrument having a sensitivity range including the range of the wavelength; and
measuring a substrate temperature of the substrate by analyzing the infrared ray radiated from the substrate by the temperature-measuring instrument.

10. The substrate temperature measuring method of claim 9, wherein the substrate temperature is measured while performing crystal growth for a semiconductor layer on the substrate.

11. The substrate temperature measuring method of claim 9, wherein transmittance of an infrared ray in at least a part of the range of the wavelength through the transmission window is 80% or more.

12. The substrate temperature measuring method of claim 9, wherein transmittance of an infrared ray with a wavelength of 8 μm through the transmission window is 80% or more.

13. The substrate temperature measuring method of claim 12, wherein the transmission window is made of barium fluoride.

14. The substrate temperature measuring method of claim 12, wherein the sensitivity range of the wavelength of the temperature-measuring instrument is 8 μm or more.

15. The substrate temperature measuring method of claim 9, wherein the temperature-measuring instrument is a thermography.

16. The substrate temperature measuring method of claim 15, wherein the thermography includes an infrared detection instrument of a bolometer type.

17. The substrate temperature measuring method of claim 9, wherein the heating source is an infrared lamp or an infrared laser.
